(19) United States
(12) Patent Application Publication
(10) Pub. No.: US 2008/0110927 A1
(43) Pub. Date: May 15, 2008

(54) Method And Plant For The Production Of Confectionery

(76) Inventors: Uwe Steiner, Numbrecht (DE); Karl-Jurgen Kasemann, Meinerzhagen (DE); Michael Paul, Bergneustadt (DE)

Correspondence Address: Klaus P. Stoffel;Wolff & Samson, One Boland Drive, West Orange, NJ, 07052, US

(21) Appl. No.: 11/661,515

(22) PCT Filed: Aug. 9, 2005
(86) PCT No.: PCT/IB05/52637

§ 371 Date: Feb. 26, 2007

(30) Foreign Application Priority Data
Aug. 25, 2004 (DE) 102004041365.7

(51) Int. Cl. B67D 5/16

(52) U.S. Cl. 222/71

(57) ABSTRACT

The invention relates to a plant for the production of optionally decorated confectionery from at least one liquid to viscous starting mass, said plant comprising a dosing unit, for the dosed introduction of mass to a dosing location, a positioning means, for carrying out a relative positioning between the dosing unit and the dosing position and a transport means for the removal of the dosed masses in the dosing location. According to the invention, the plant further comprises a data processing system with input means, display means and a memory, a comparator, a method parameter calculating means which designates process parameters of the production method and/or machine parameters of the plant according to a given calculated schema, for the product parameters inputted via the input means and a control system comprising actuators.

The invention relates to a method and device for manufacturing confectionery products out of at least one liquid to viscous initial compound.

The at least one initial compound typically involves fat-based, conveyable or free-flowing compounds such as dark or milk chocolate, or frosting-like compounds. Such initial compounds can be cast at a sufficiently high temperature (fat compounds, chocolate) or given a sufficiently high water content (frosting), and solidified by subsequently reducing the temperature or drying.

As a rule, such devices for manufacturing confectionery products have a metering unit for metering the compound into a metering location; a positioning means for establishing a relative position between the metering unit and metering location; along with a transport means for transporting the compound metered into the metering location in and out. If needed, a cooling unit can be included as well.

In order to implement the method for manufacturing confectionery products using such a device, correctly operating the device proceeding from the desired properties of the confectionery article to be fabricated, i.e., the product parameters, requires some experience, i.e., in selecting the right process parameters and/or machine parameters for the device.

The object of the invention is to eliminate these difficulties in operating the device mentioned at the outset for the less experienced system operator, and also to help experienced system operators optimize a process.

This object is achieved by the device according to claim 1, and the method according to claim 13.

To this end, the device according to the invention has:
A metering unit for metering the compound to a metering location;
A positioning means for establishing a relative position between the metering unit and metering location;
If needed, a transport means for transporting the compound metered to the metering location in and out;
A data processing system equipped with input and display means, along with a storage means, comparison means and process parameter computing means, which can allocate process parameters of the manufacturing method and/or machine parameters of the device to product parameters of the confectionery articles that can be entered via the input means according to a prescribed or computable scheme; and
A control system with actuators.

In the method according to the invention for manufacturing confectionery articles out of the at least one liquid to viscous compound with the use of the device according to the invention,
Product parameters that define a confectionery article to be manufactured are initially entered via input means of a control system; and
Process parameters of the confectionery manufacturing method and/or machine parameters for the device used for manufacture are allocated to the product parameters based on a prescribed scheme or according to a computation performed by the computing means.

Based on this scheme or the computation performed by the computing means, the process parameters and/or machine parameters for controlling the manufacturing method are allocated to the desired product parameters.

Utilizing these process parameters and/or machine parameters, the control system of the device according to the invention controls the following:
The metered supply of the compound to a metering location by means of a metering unit;
The relative positioning and/or moving of the metering unit and the metering location by means of a positioning means; and, if needed;
The outward transport of compound metered to the metering location by means of a transport means. Outward transport can take place manually or automatically.

Therefore, the invention simplifies device operation. The device according to the invention can be operated even without in-depth knowledge of machines. When entering parameters into the machine, the device or machine operator can concentrate on product parameters that describe the confectionery articles to be fabricated, and does not have to input any device or machine parameters. Hence, the invention helps to tangibly improve the man/machine interface in a device for manufacturing confectionery products.

The metering unit of the device according to the invention preferably has a die, a piston/cylinder unit and a valve, wherein the cylinder volume of the piston/cylinder unit fluidically communicates either with the compound supply or compound container, or with the die, depending on the position of the valve.

The piston is either a “sliding piston” that can be axially moved between two axial operating positions in the cylinder, or a “rotating piston”, which can be turned around the cylindrical axis in the cylinder between two rotational operating positions in the cylinder. In addition, a combination of sliding and rotating pistons can be used as the piston. Other mechanisms that distribute by volume or weight can also be used.

In a particularly preferred embodiment of the metering unit, metering takes place by means of a lifting/rotating piston, which combines the function of the valve and pressure generation. This lifting/rotating piston has a recess, thereby defining a metering volume between the cylinder chambers in which the lifting/rotating piston is lockably and rotatably mounted. This metering volume is increased in an intake stroke of the lifting/rotating piston, thereby drawing the compound into the metering volume. Turning the lifting/rotating piston interrupts the connection between the compound supply, replacing it with a connection to the die. A discharge stroke proceeding opposite the initial stroke subsequently reduces the metering volume, so that the compound contained in the metering volume is forced out of the metering volume through the die (e.g., a casting mold).

The device according to the invention can exhibit a compound container fluidically connected with the metering unit for storing and providing the liquid to viscous compound.

A predetermined metering location is preferably used as the metering location. In particular, the metering location is a casing mold or a flat surface, into or on which a viscous compound is poured. The casting mold can be a part of the packaging of the confectionery, or a mold/cold stamp unit.

The positioning means preferably has a means for moving the die and/or, if needed, a means for moving the metering location.

The drive of the positioning means best consists of an actuator, while the drive of the piston for the piston/cylinder unit consists of at least a second actuator. The drive of the valve preferably also consists of another actuator.

In a particularly advantageous embodiment, the device according to the invention has a confectionery article scanning device for acquiring the shape of a confectionery article placed therein, wherein the scanning device is connected with the storage means. This scanning device enables a rapid input of the geometric data or specific shape of a desired confectionery article. This is useful in particular for confectionery articles formed by apportioning heaps of a viscous compound with sufficient dimensional stability. To this end, the operator can input a model of the desired confectionery article fabricated by hand beforehand into the scanning device. The data processing system of the device according to the invention then determines the necessary machine and process parameters for manufacturing this confectionery article.

At least one or combinations of the following parameters for the confectionery article are input as product parameters for the method according to the invention: Weight; sleeve/filling weight ratio; density, density of sleeve initial compound, density of filling initial compound; volume; length, width, height; geometric shape of article; geometry of article decoration; density of decorative initial compound; viscosity of sleeve initial compound; viscosity of filling initial compound. The geometric shape of the article and an article decoration, e.g., in the form of a pattern or lettering, are preferably detected by the scanning device described further above. Therefore, this scanning device produces a three-dimensional or two-dimensional input of the article shape or article decoration.

The metering unit and metering location can be relatively positioned and/or moved in such a way that a die of the metering unit moves along a predetermined path at the resting metering location. For example, this makes it possible to cast bands, strips, pretzels, etc. on the path from the compound.

The metering unit and metering location can also be relatively positioned and/or moved in such a way that a die of the metering unit moves along the resting surface of a confectionery article on a predetermined path. Previously molded confectionery articles can be decorated in this way.

In another advantageous embodiment, after inputting product parameter combinations and allocating process parameters and/or machine parameters in the method according to the invention, the comparison means of the device according to the invention compares the input product parameter combination with stored, impossible product parameter combinations in the storage means, and the operator is notified via the display means whether an input product parameter combination is possible or not. This makes the operator aware of potential problems in advance, and he is provided with a decision-making aid when designing the manufacturing method for the confectionery articles.

Given the entry of an impossible product parameter combination, at least one stored possible alternative product parameter combination is preferably displayed, which differs by as few parameters as possible from the input impossible combination. This provides the operator with suggestions on how to design the manufacturing process, simplifying its optimization. The difference between the varying parameters is preferably as small as possible with respect to the different parameters for an impossible and possible alternative product parameter combination. The deviation of the possible parameter combination proposed by the device from the impossible parameter combination suggested by the operator is preferably quantified by the standard deviation between the impossible parameter group and possible parameter group, and then minimized. Parameters intended to barely deviate from the originally desired impossible parameters if at all given the proposed alternative product parameter combination can be weighted more strongly during this statistical evaluation via standard deviation and the like than the other parameters.

It is important that the operator and/or the data processing system decide whether an input or displayed alternative product parameter combination is acceptable.

To decorate the surface of a confectionery article, the geometric shape of the confectionery article can be input via the confectionery article scanning device by placing the confectionery article to be decorated therein for acquiring its geometric data, storing the geometric data in the storage means, and using the stored geometric data for actuating the positioning means in order to relatively position and/or move the metering unit and metering location.

The data processing system used in the device according to the invention with a storage means, a comparison means and a process parameter calculating means, which can allocate process parameters for the manufacturing process and/or machine parameters for the device to the product parameters of the confectionery article that can be entered via the input means based on a prescribed or computable scheme, is preferably comprised of a system of fuzzy logic or a neuronal net. A combination of fuzzy logic and neuronal net can be used as an alternative. Obtained in this way is a learning-capable data processing system or an expert system that operates similarly to an experienced system operator or process engineer.

Additional features, advantages and possible applications of the invention can now be gleaned from the following description of examples based on the drawing, wherein:

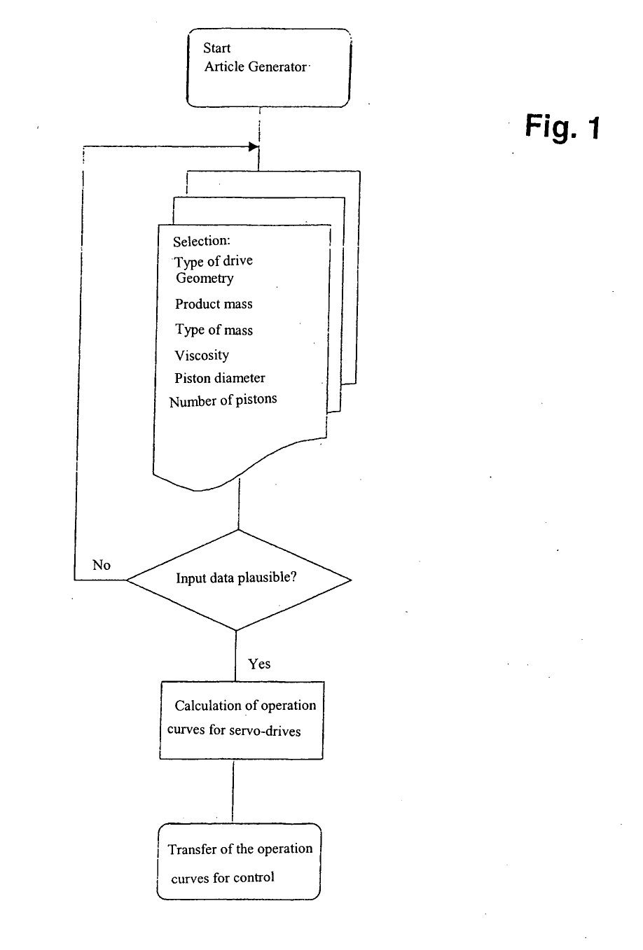

FIG. 1 shows a diagrammatic flowchart of the method according to the invention for manufacturing confectionery articles;

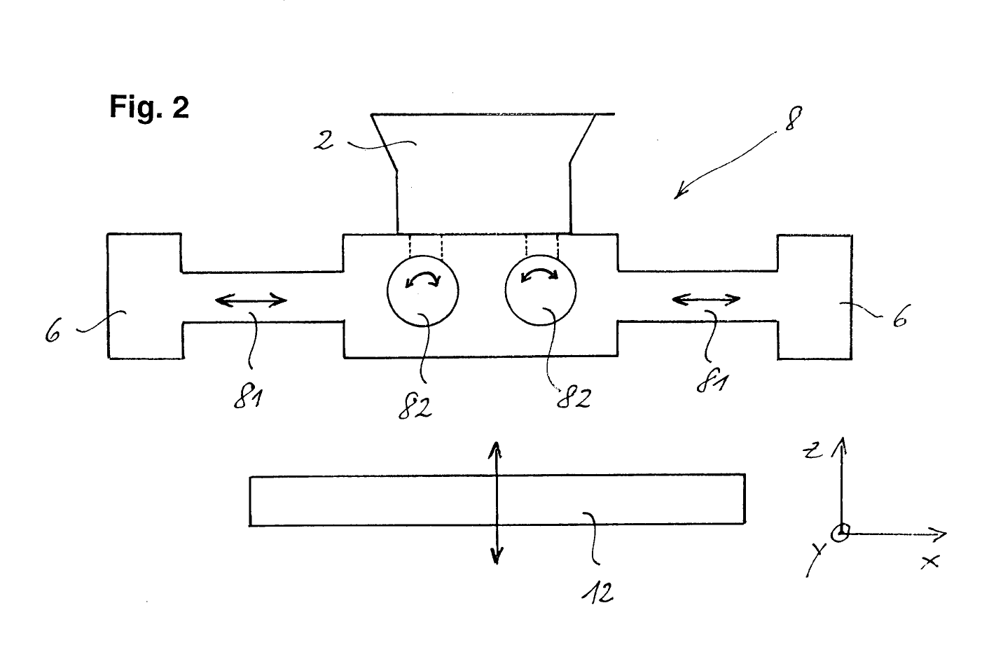

FIG. 2 shows a diagrammatic view of a device according to the invention;

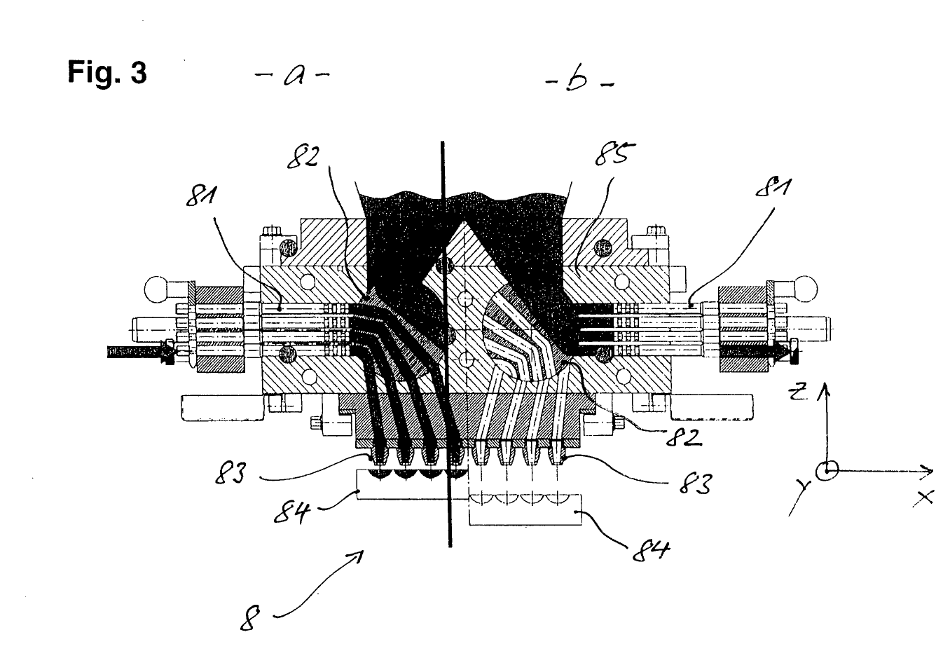

FIG. 3 shows a diagrammatic view of a portion of the device according to the invention; and

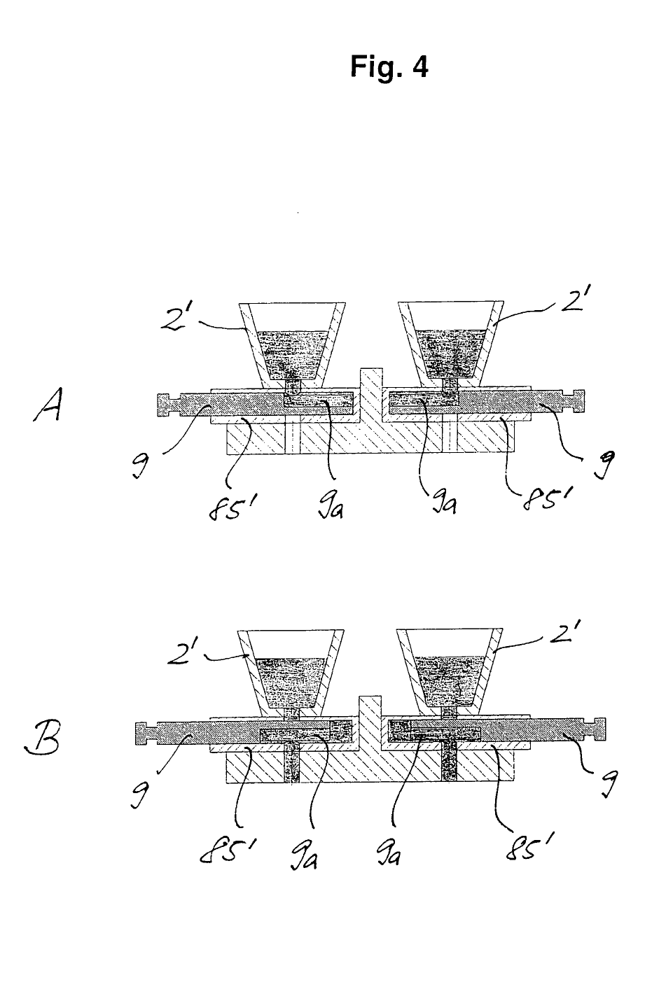

FIG. 4 shows a diagrammatic view of an alternative portion of the device according to the invention.

The interactive system for interaction between the operator and device according to the invention as shown on FIG. 1 and referred to as an “article generator” operates as follows:

The operator starts the article generator, which then prompts him to input certain parameters. However, it is not crucial here that the operator makes an entry for all parameters. The operator must make an entry only for a portion of the displayed parameters.

The parameter combination input by the operator is evaluated by the article generator, during which a comparison takes place with the possible parameter combinations and/or impossible parameter combinations, for example.

If the input parameter combination is possible or the input data are plausible, the motion curves for the necessary servo drives are calculated or suitably selected from a stored plurality of motion curves allocated to the respective parameter combinations.

If the input parameter combination is not possible or the input data are implausible, the operator is again prompted to enter a modified selection of the specific parameters. This can be repeated until the input parameter combination is possible or the input data are plausible. This trial and error process can be supported by system suggestions (not shown on FIG. 1) that reveal potentially possible parameter combinations to the operator.

The drives for transporting the molds in and out, for example, are not actuated by the article generator, but separately.

FIG. 2 shows a diagrammatic view of a device according to the invention. It has a compound container 2, a traversing drive (not shown), a piston drive 6, a piston system 8, a basic framework (not shown), as well as a lifting platform 12.

The compound container 2 is used to store and heat the compound to be processed. The compound container 2 is connected with a piston system 8 (see FIG. 3), which is used for metering/portioning the compound and filling the compound into molds 84 (see FIG. 3) arranged on the lifting platform 12. The traversing drive is used to move (strict translation) the molds 84 or dies 83 along traversing axes in an x-direction, a y-direction and a z-direction. The piston drive 6 has a displacement drive 61 for driving displacement pistons 81 and a rotating drive 62 for driving rotating pistons 82 (see FIG. 3). A lifting platform is not absolutely necessary if the traversing drive of the machine has a traversing axis in the z-direction.

During operation, the liquid to viscous compound is supplied to the compound container 2. From there, it is metered or portioned via the piston system 8 (see FIG. 3), and filled into casting molds at defined positions. As an alternative, small heaps of portioned compound can be deposited on a substrate (e.g., belt).

Relative positioning between the dies 83 and molds 84 takes place via the traversing drive in the x-direction, and if necessary, additional traveling drives in the y-direction and z-direction.

The compound for the respective casting process or respective heap formation is positioned/metered via the displacement drive 61 of the displacement pistons 81, which hence act as “metering pistons”.

Switching between the first position of the rotating pistons 82 in which the latter are fluidically connected with the compound container 2 and the second position of the rotating pistons 82 in which the latter are fluidically connected with the die 83 takes place via the rotating drive 62 of the rotating piston 82, which hence act as a “switching valve”.

Therefore, the device shown on FIG. 2 has the following drives:
Traversing drive in the x-direction for relatively positioning the die/mold
Traversing drive in the y-direction for relatively positioning the die/mold
Traversing drive in the z-direction for relatively positioning the die/mold
Displacement drive (metering piston drive)
Rotating drive (switching valve drive)

FIG. 3 presents a detailed view of the piston system 8 along a cutting plane perpendicular to the rotating axis of the rotating drive of the rotating piston 82. The displacement pistons 81 and rotating pistons 82 are mounted in a piston casing 85.

Four displacement pistons (metering pistons) 81 are in a position approximating the rotating piston (switching valve) 82 on the left side of FIG. 3. At the same time, one of the rotating pistons 82 is in a position in which the respective cylinder volumes of the four displacement pistons 81 are fluidically connected with the dies 83. The rotating piston 82 has four channels, which each produce this fluidic connection in this position.

The state of the piston system 8 shown on the left of FIG. 3 corresponds to the end of the metering stroke of the metering pistons 81. In this state, the molds 84 are filled with compound, and can be relayed to inward and outward mold transport via the transport means.

The right side of FIG. 3 shows the four displacement pistons (metering pistons) 81 in a position removed from the rotating piston (switching valve) 82. At the same time, the rotating piston 82 is in a position where the respective cylinder volumes of the four displacement pistons 81 are each fluidically connected with the compound container 2.

The state of the piston system 8 shown on the right of FIG. 3 is a snapshot of the intake of compound from the compound container 2 into the cylinder volume of the metering pistons 81. The molds 84 are not yet filled with compound in this state. In short order, the rotating piston 82 will move into a position in which the fluidic connection is established between the compound container 2 and the dies 83, and metering stroke of the displacement piston 81 will take place for metering the compound into the mold.

Therefore, the device according to the invention enables the following types of procedures:
Spot casting in stationary or moving mold
Strip casting in stationary or moving mold
One-shot spot casting in stationary or moving mold
One-shot strip casting in stationary or moving mold
Filling/lidding during spot casting in stationary or moving mold
Filling/lidding during strip casting in stationary or moving mold
Decorating
Dressing

FIGS. 4A and 4B show an embodiment of the metering unit as an alternative to the one on FIG. 3. The metering unit contains twin sets of a compound container 2, a piston casing 85′ and a lifting/rotating piston 9, which is a combination of lifting piston and rotating valve. The lifting/rotating piston 9 is mounted so that it can shift in the piston casing 85′ and rotate around the displacement axis. In addition, the lifting/rotating piston 9 has a recess 9a, so that a metering volume is defined between the piston casing 85′ and the lifting/rotating piston.

FIG. 4A shows the beginning of a suction stroke, in which the lifting/rotating piston 9 in the piston casing 85′ is shifted in such a way as to enlarge the cavity between the recess 9a and piston casing 85′.

FIG. 4B shows the beginning of a metering stroke, in which the lifting/rotating piston 9 in the piston casing 85′ is shifted opposite to the suction stroke in such a way as to reduce the cavity between the recess 9a and piston casing 85′.

At the end of the suction stroke (not shown), the lifting/rotating piston is turned around its longitudinal or rotating axis by 180°, moving it into the position shown on FIG. 4B.

The compound volume conveyed to the die (not shown) during the metering stroke corresponds to the difference between the minimum cavity volume (see FIG. 4A) at the beginning of the suction stroke and the maximum cavity volume (see FIG. 4B) at the end of the suction stroke or beginning of the metering stroke. The rotation of the lifting/rotating piston 9 between the end of the suction stroke and beginning of the metering stroke does not alter the cavity volume in this example, but rather only involves switching from the liquid connection between the compound container 2 and the cavity volume to the fluid connection between the compound container 2 and die.

In the one-shot process, articles filled in a single metering process are manufactured. A special die and special mold are used for this purpose. The die has a central channel for filling compound, and an annular channel enveloping the central channel for sleeve compounds. A single “shot” simultaneously atomizes filling compound and sleeve compound through this die into a specially designed mold. The geometry of the die and mold along with the atomization dynamics are tailored to each other in such a way that the sleeve compound (in one-shot spot casting) is distributed completely around the filling compound, forming a filled article.

During spot welding in a stationary mold, the operator selects a previously defined geometric shape for the confectionery articles to be manufactured. The operator uses the input means to then enter the product parameters, i.e., the radius, semi-axes, etc. Other product parameters such as density and viscosity can also be input.

The computing means calculates the appropriate process parameters from the above, e.g., the metering quantity, the metering rate via the at least one displacement piston 81, as well as the movement of the molds 84 in a vertical direction or along the z-axis, or it selects potential combinations of process parameters from a plurality of prescribed allocations between product parameters and process parameters.

During strip casting in a stationary mold, the operator also selects a previously defined geometric shape for the article to be manufactured. Length, width, height or length and radius or length and semi-axes are here selected as the product parameters for a square, circular or elliptically cylindrical bar. Product parameters like compound density and viscosity can again be input.

The computing means calculates the appropriate process parameters from the above, e.g., the metering quantity, the metering rate via the at least one displacement piston 81, as well as the movement of the molds 84 in a vertical direction or along the z-axis, and in a horizontal longitudinal direction or along the x-axis and/or y-axis, or it again selects potential combinations of process parameters from a plurality of prescribed allocations between product parameters and process parameters.

During one-shot spot casting in a stationary mold, the operator also selects a previously defined geometric shape for the filled article to be manufactured. In the case of a filled ball, for example, the ball radius and sleeve thickness are input. Other product parameters like sleeve compound and filling compound density and viscosity can again be input.

The computing means calculates the appropriate process parameters from the above, e.g., the metering quantity, the metering rate via the two displacement pistons 81, as well as the movement of the molds 84 in a vertical direction or along the z-axis.

During one-shot strip casting in a stationary mold, the operator also selects a previously defined geometric shape for the filled article to be manufactured. In the case of a filled bar, for example, the length, width and height of the bar along with the sleeve thickness are input. Other product parameters like sleeve compound and filling compound density and viscosity can again be input.

The computing means calculates the appropriate process parameters from the above, e.g., the metering quantity for the filling compound and sleeve compound, the respective metering rate for the filling compound and sleeve compound via the two displacement pistons 81, as well as the movement of the molds 84 in a vertical direction or along the z-axis, and in the horizontal longitudinal direction or along the x-axis and/or y-axis.

During spot casting, strip casting, one-shot spot casting and one-shot strip casting in a respectively moving mold, the process parameters correspond to those for the respective casting type in the stationary mold. The chronological progression of movement in the horizontal longitudinal direction or along the x-axis (traversing curve for the x-axis) is then prescribed by a downstream control system.

In the aforementioned casting types, the geometric product parameters can also be entered via a confectionery article scanning device by supplying the latter with a geometric model of the article to be manufactured, and scanning and storing its dimensions.

During decoration, prescribed patterns and/or letterings can be input.

If decoration involves lettering and/or a pattern on the flat surface of a confectionery article, input takes place via a writing tablet or a mouse.

The computing means calculates the appropriate process parameters from the above, e.g., the metering quantity for the decoration compound, the respective metering rate for the decoration compound via at least one displacement piston 81, as well as the movement of the confectionery articles in a vertical direction or along the z-axis, and in the horizontal longitudinal direction or along the x-axis, and along the horizontal transverse direction or along the y-axis. The distance covered by the decoration curve is first calculated from the above, and used to again compute the movement of the metering piston.

If decoration involves lettering on an uneven surface of a confectionery article (e.g., Santa or the Easter Bunny), the vertical projection (x-coordinates and y-coordinates) of the decoration are also input via a writing tablet or a mouse. In addition, the respective height (z-coordinate) must still be entered, e.g., manually, for the individual points of this projection.

In the above decoration type, the geometric product parameters for the pattern and/or lettering can also be input via a confectionery scanning device having a scanning stylus, with which the uneven surface of the article or a model of this article is scanned along the pattern and/or lettering to be incorporated. A curve in space or on the uneven surface of the article is acquired in this way. This geometric curve information is then stored in the storage means.

The computing means again calculates the appropriate process parameters from the above, e.g., the metering quantity for the decoration compound, the respective metering rate for the decoration compound via at least one displacement piston 81, as well as the movement of the respective confectionery article or die in a vertical direction or along the z-axis, and in the horizontal longitudinal direction or along the x-axis, and along the horizontal transverse direction or along the y-axis. The distance covered by the decoration curve is first calculated from the above, and used to again compute the movement of the metering piston.

1. A device for manufacturing confectionery products out of at least one liquid to viscous initial compound or compounds with ingredients, wherein the device comprises:
a unit for supplying the compound to a metering unit that prepares or stores the compound;
a metering unit (8) for metering the compound to a metering location;
a positioning means (4) for establishing a relative position between the metering unit and metering location;
a transport means for transporting the compound metered to the metering location in and out;
a data processing system equipped with input and display means, along with a storage means, and
a control system with actuators,
wherein the metering unit (8) has a die (83), a piston/cylinder unit (81) and a valve (82), wherein the cylinder volume of the piston/cylinder unit fluidically communicates either with the metering unit or the die, depending on the position of the valve, and that the data processing means exhibits a comparison means and process parameter computing means, which can allocate process parameters of the manufacturing method and/or machine parameters of the device to product parameters of the confectionery articles to be manufactured, which can be input via the input means according to a prescribed or computable scheme.

2. The device according to claim 1, and further comprising a compound container fluidically connected with the metering unit for holding and providing the liquid to viscous compound.

3. The device according to claim 1, wherein the metering location is a predetermined metering location.

4. The device according to claim 3, wherein the metering location is a casting mold.

5. The device according to claim 4, wherein the casting mold is part of the confectionery packaging.

6. The device according to claim 1, wherein the metering location is a mold/cold stamping unit.

7. The device according to claim 1, wherein the positioning means is a means for moving the die and/or a means for

8. The device according to claim 1, wherein a first actuator is a drive of the positioning means.

9. The device according to claim 8, wherein a second actuator is a drive of the piston in the piston/cylinder unit.

10. The device according to claim 1, wherein one actuator is the valve drive.

11. The device according to claim 1, and further comprising a confectionery article scanning device for acquiring the shape of a confectionery article placed therein, wherein the scanning device is connected with the storage means.

12. A method for manufacturing confectionery products out of at least one liquid to viscous initial compound or compounds with ingredients, using a device according to claim 1, in which:
product parameters that define a confectionery article to be manufactured are initially entered via input means of a control system; and
process parameters of the confectionery manufacturing method and/or machine parameter for the device used for manufacture are allocated to the product parameters based on a prescribed scheme or according to a computation performed by the computing means,
in order to execute the following manufacturing steps using the allocated process parameters and/or machine parameters for controlling the manufacturing process:
the metered supply of the compound to a metering location by means of a metering unit;;
the relative position and/or moving of the metering unit and the metering location by means of a positioning means; and
the outward transport of compound metered to the metering location by means of a transport means,
wherein, after the product parameter combinations have been input and before process parameters and/or machine parameters have been allocated, the comparison means compares the input product parameter combination with stored, impossible product parameter combinations in the storage means, and the operator is notified via the display means whether an input product parameter combination is possible or impossible.

13. The method according to claim 12, wherein at least one or combinations of the following parameters for the confectionery article are input as the product parameters:
Weight
Sleeve/filling weight ratio
Density
Density of sleeve initial compound
Density of filling initial compound
Volume
Length, width, height
Geometric shape
Geometry of article decoration
Density of decoration initial compound
Viscosity of sleeve initial compound
Viscosity of filling initial compound

14. The method according to claim 12, wherein
the metering unit and metering location are relatively positioned and/or moved in such a way that a die of the metering unit is moved along a predetermined path at the resting metering location.

15. The method according to claim 12 the metering unit and metering location are relatively positioned and/or moved in such a way that a die of the metering unit is moved along the resting surface of a confectionery article on a predetermined path.

16. The method according to claim 12, wherein if an impossible product parameter combination is entered, at least one stored possible alternative product parameter combination is preferably displayed, which differs by as few parameters as possible from the input impossible combination.

17. The method according to claim 12, wherein the respective difference between the varying parameters is preferably as small as possible with respect to the different parameters for an impossible and possible alternative product parameter combination.

18. The method according to claim 12, wherein the operator and/or the data processing system decides whether an input or displayed alterative product parameter combination is acceptable.

19. The method according to for decorating the surface of a confectionery article, wherein the geometric shape of the confectionery article, wherein the geometric shape of the confectionery article is input via a confectionery article scanning device by placing the confectionery article to be decorated therein for acquiring its geometric data, storing the acquired geometric data in the storage means, an using the stored geometric data for actuating the positioning mean in order to relatively position and/or move the metering unit and metering location.
